(19) United States
(12) Patent Application Publication
(10) Pub. No.: US 2005/0198851 A1
(43) Pub. Date: Sep. 15, 2005

(54) Drying machine

(76) Inventors: Kazuyoshi Tomochika, Ora-gun (JP); Koji Ono, Ora-gun (JP)

Correspondence Address: MCDERMOTT WILL & EMERY LLP, 600 13TH STREET, N.W., WASHINGTON, DC, 20005-3096, US

(21) Appl. No.: 11/074,947

(22) Filed: Mar. 9, 2005

(30) Foreign Application Priority Data
Mar. 9, 2004 (JP) 2004-065477
Mar. 10, 2004 (JP) 2004-067397

(51) Int. Cl. F26B 21/06; F26B 3/00

(52) U.S. Cl. 34/74; 34/468

(57) ABSTRACT

An object is to provide a drying machine capable of reducing vibration generated by rotation of a rotary drum. There is provided a drying machine which executes a drying operation of a matter to be dried in a housing chamber constituted in an inner drum of a drum main body constituted of an outer drum and the inner drum disposed inside the outer drum, the drying machine comprising: a refrigerant circuit constituted by successively piping/connecting a compressor, a gas cooler, an expansion valve, and an evaporator in an annular shape; and an air circulation path for discharging air whose heat has been exchanged with the gas cooler into the housing chamber by a blower fan, and allowing the air which has passed through the housing chamber to exchange the heat with the evaporator, wherein a drum main body is attached to a base via a suspension, and the compressor is attached to a lower part of the drum main body.

### BACKGROUND OF THE INVENTION

The present invention relates to a drying machine which executes a drying operation of a matter to be dried in a housing chamber constituted in a rotary drum of a drum main body.

This type of drying machine has heretofore comprised: a drying unit constituted of an electric heater, a heat source of a gas burning heater, a fan, and a driving motor in a main body; and a rotary drum in which a housing chamber for housing a matter to be dried is formed. Moreover, air blown by a fan (blowing means) is heated by the electric heater or the gas burning heater, and thereafter blown to the housing chamber in the rotary drum to dry the matter to be dried in the housing chamber.

In this drying machine, a drying unit is independently disposed above the rotary drum, the drying unit and the rotary drum are connected to a flexible duct having flexibility, and vibration transmitted to the drying unit from the rotary drum is reduced (see, e.g., Japanese Patent Application Laid-Open No. 5-123486).

Moreover, as a washing/drying machine which executes a washing operation and which executes a drying operation after ending the washing operation, a machine has been developed in which a tank storing rinsing water for use in a rinsing step of the washing operation is disposed in a bottom part of a main body, and center of gravity of the washing/drying machine is set in a lower part to thereby enhance stability (see, e.g., Japanese Patent Application Laid-Open No. 2-36893).

On the other hand, in the drying machine using the electric heater or the gas burning heater, since outside air having a low temperature outside the housing chamber and containing humidity is used in high-temperature air sent into the housing chamber, long time is required until the matter to be dried dries. Therefore, energy consumption for drying the matter to be dried increases, and there has been a problem that energy costs such as electricity and gas charges soar.

To solve the problem, a drying machine has also been developed which is constituted of a compressor, a radiator, an expansion valve (pressure reducing device), and an evaporator and which utilizes a heat pump capable of circulating a heat exchange medium. The matter to be dried is dried by high-temperature air heated by the radiator, humidity evaporated from the dried matter is condensed and dehumidified in the evaporator, and the condensed water content is discarded.

There has been an earnest demand for reduction of vibration generated by rotation of the rotary drum even in the drying machine using the heat pump.

### SUMMARY OF THE INVENTION

The present invention has been developed to solve the conventional problem, and an object thereof is to provide a drying machine capable of reducing vibration generated by rotation of a rotary drum.

That is, according to the present invention, there is provided a drying machine which executes a drying operation of a matter to be dried in a housing chamber constituted in a rotary drum, the drying machine comprising: a refrigerant circuit constituted by successively piping/connecting a compressor, a radiator, a pressure reducing device, and an evaporator in an annular shape; and an air circulation path for discharging air whose heat has been exchanged with the radiator into the housing chamber by blowing means, and allowing the air which has passed through the housing chamber to exchange the heat with the evaporator, wherein a drum main body is attached to a base via a suspension, and the compressor is attached to a lower part of the drum main body.

According to the present invention, in the drying machine which executes the drying operation of the matter to be dried in the housing chamber constituted in the rotary drum, there are disposed: the refrigerant circuit constituted by successively piping/connecting the compressor, radiator, pressure reducing device, and evaporator in the annular shape; and the air circulation path for discharging the air whose heat has been exchanged with the radiator into the housing chamber by the blowing means, and allowing the air which has passed through the housing chamber to exchange the heat with the evaporator. The drum main body is attached to the base via the suspension, and the compressor is attached to the lower part of the drum main body. Therefore, the compressor performs a function of a deadweight with respect to the drum main body, amplitude of the vibration generated when the rotary drum rotates is suppressed, and a resonance frequency drops.

Consequently, in addition to a vibration absorption effect of a suspension, vibration•noise during operation can be remarkably reduced.

Moreover, in the drying machine of the present invention, in the above-described invention, the refrigerant circuit including the compressor, or the refrigerant circuit and the blowing means are attached to the lower part of the drum main body.

According to the present invention, additionally the refrigerant circuit including the compressor, or the refrigerant circuit and blowing means are attached to the lower part of the drum main body. Therefore, the refrigerant circuit including the compressor, and the blowing means function as the deadweights with respect to the drum main body, and vibration can be further suppressed. Especially, in this case, a flexible hose for absorbing displacement does not have to be used in the air circulation path between the refrigerant circuit and the drum main body, and component cost can be reduced.

Moreover, in the drying machine of the present invention, in the above-described invention, the refrigerant circuit, or the refrigerant circuit and the blowing means are integrally constituted, and detachably attached to the lower part of the drum main body.

According to the present invention, additionally, the refrigerant circuit, or the refrigerant circuit and the blowing means are integrally constituted, and detachably attached to the lower part of the drum main body. Therefore, assembly operability at production and maintenance times is remarkably enhanced.

Furthermore, in the drying machine of the present invention, in the above-described inventions, the compressor, the refrigerant circuit, or the refrigerant circuit and blowing means are disposed in a predetermined range below the center of gravity of the drum main body.

According to the present invention, in addition to the above-described inventions, the compressor, the refrigerant circuit, or the refrigerant circuit and blowing means are disposed in a predetermined range below the center of gravity of the drum main body. Therefore, amplitude of vibration of the drum main body can be securely reduced.

Moreover, according to the present invention, there is provided a drying machine which executes a drying operation of a matter to be dried in a housing chamber constituted in a rotary drum of a drum main body, the drying machine comprising: a refrigerant circuit constituted by successively piping/connecting a compressor, a radiator, a pressure reducing device, and an evaporator in an annular shape; and an air circulation path for discharging air whose heat has been exchanged with the radiator into the housing chamber by blowing means, and allowing the air which has passed through the housing chamber to exchange the heat with the evaporator, wherein the refrigerant circuit and the blowing means are integrally constituted as a cassette, and detachably attached.

According to the present invention, in the drying machine which executes the drying operation of the matter to be dried in the housing chamber constituted in the rotary drum of the drum main body, there are disposed: the refrigerant circuit constituted by successively piping/connecting the compressor, radiator, pressure reducing device, and evaporator in the annular shape; and the air circulation path for discharging the air whose heat has been exchanged with the radiator into the housing chamber by the blowing means, and allowing the air which has passed through the housing chamber to exchange the heat with the evaporator. The refrigerant circuit and the blowing means are integrally constituted as the cassette, and detachably attached. Therefore, both the heating by the radiator and the dehumidifying by the evaporator are performed in the refrigerant circuit. Accordingly, the drying operation of the matter to be dried is efficiency performed, and assembly operability•maintenance operability of the refrigerant circuit and blowing means can be remarkably enhanced.

Moreover, in the drying machine of the present invention, in the above-described invention, the cassette is attached to the lower part of the drum main body.

According to the present invention, since the cassette is attached to the lower part of the drum main body, the center of gravity of the drum main body is lowered, generation of vibration at an operation time is suppressed, and sounds can be reduced.

Furthermore, in the drying machine of the present invention, in the above-described invention, the cassette is attached to a base to which the drum main body is attached.

According to the present invention, the cassette is attached to the base to which the drum main body is attached, therefore the center of gravity of a drying machine main body is lowered, stability is enhanced, and sounds can be reduced.

Additionally, in the drying machine of the present invention, in the above-described invention, the cassette is drawably attached, and the air circulation path is constituted by an inserting operation.

According to the present invention, in addition to the above-described inventions, the cassette is drawably attached, and the air circulation path is constituted by the inserting operation. Therefore, an assembly operation can be further facilitated, and maintenance property can be enhanced.

### BRIEF DESCRIPTION OF THE DRAWINGS

FIG. 1 is an inner constitution diagram of a washing/drying machine according to one embodiment of a drying machine of the present invention;

FIG. 2 is an inner constitution diagram of a state in which a drying unit of the washing/drying machine of FIG. 1 is taken out;

FIG. 3 is a sectional view of the washing/drying machine of FIG. 1;

FIG. 4 is a sectional view of the washing/drying machine of FIG. 1;

FIG. 5 is an inner constitution diagram of the drying unit;

FIG. 6 is a front view of the drying unit and an installation base;

FIG. 7 is a diagram showing a part of the drying unit fixed to the installation base;

FIG. 8 is a diagram showing a method of connecting the drying unit to a duct member;

FIG. 9 is a diagram showing a method of connecting the drying unit to the duct member;

FIG. 10 is a diagram showing an equation of an amplitude and a resonance frequency;

FIG. 11 is a diagram showing a change of the resonance frequency following a mass change;

FIG. 12 is an inner constitution diagram of the washing/drying machine according to another embodiment of the drying machine of the present invention;

FIG. 13 is an inner constitution diagram of a state in which the drying unit of the washing/drying machine of FIG. 12 is taken out;

FIG. 14 is a front view of the drying unit and the installation base according to another embodiment; and

FIG. 15 is a diagram showing a part of the drying unit fixed to the installation base of FIG. 14.

### DETAILED DESCRIPTION OF THE PREFERRED EMBODIMENT

Embodiments of the present invention will be described hereinafter in detail with reference to the drawings.

### Embodiment 1

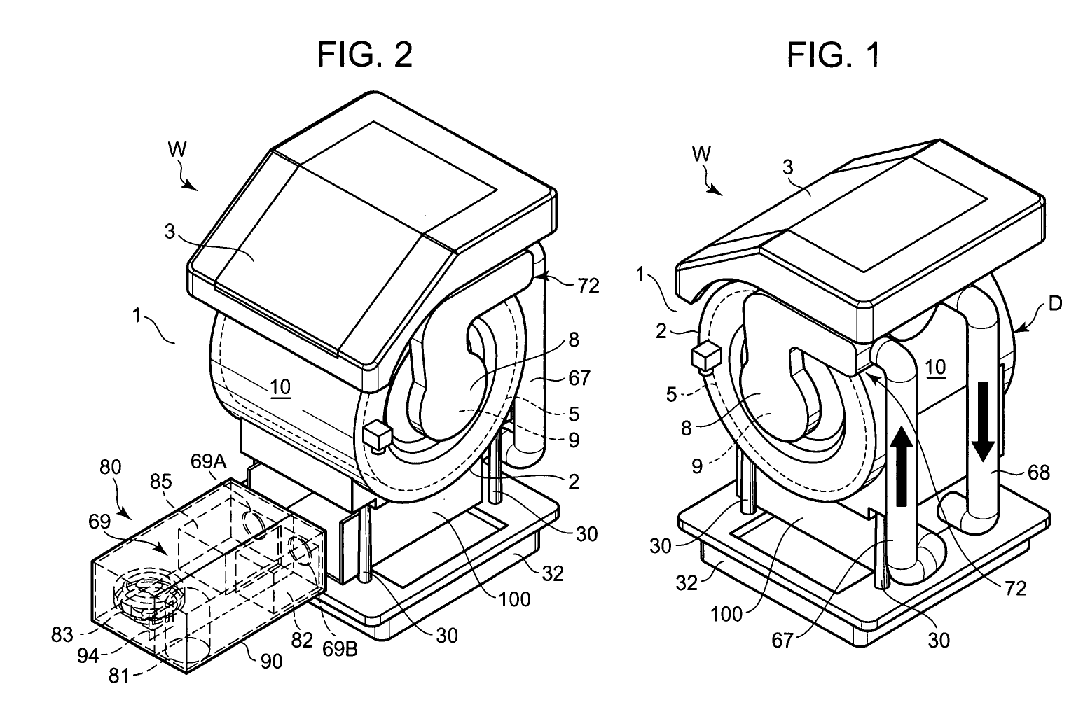

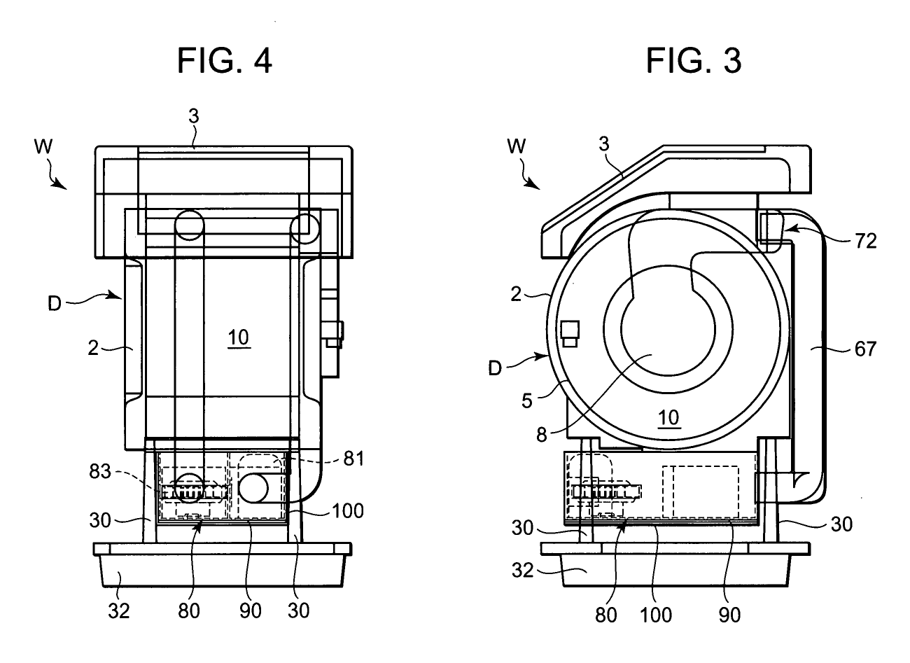

FIG. 1 is an inner constitution diagram of a washing/drying machine W which executes a washing operation and a drying operation after ending the washing operation according to one embodiment of a drying machine to which the present invention is applied, FIG. 2 is an inner constitution diagram of the washing/drying machine W in a state in which a drying unit is taken out, and FIGS. 3 and 4 are sectional views of the washing/drying machine W.

The washing/drying machine W of the present embodiment is used for washing and drying a matter to be washed such as clothing (this matter to be washed constitutes a matter to be dried in the drying operation). An open/close door 3 for inserting/removing the matter to be washed is attached to an upper surface middle part of a main body 1 (a case of the main body 1 is seen through in the drawing) forming an outer body. An operation panel (not shown) on which various operation switches and display portions are arranged is disposed on the upper surface of the main body 1 beside the open/close door 3.

In the main body 1, a drum main body D is disposed comprising: an outer drum 2 disposed along a cylinder axis which is a right/left direction, capable of storing water, and formed of a cylindrical resin; and an inner drum (rotary drum in the present invention) 5 disposed inside the outer drum 2, functioning both as a washing tank and dewatering tank, and formed of cylindrical stainless steel. Moreover, the inside of the inner drum 5 is constituted as a housing chamber (functioning as a housing chamber in a drying operation) 10 which houses the matter to be washed. This chamber is disposed along a cylinder axis which is a right/left direction. A rotation shaft is connected to a shaft 8 of a driving motor (not shown) attached to the side wall (inner side of FIG. 1) of the outer drum 2. The inner drum 5 is rotatably held in the outer drum 2 centering on the rotation shaft which is a shaft of the inner drum 5 connected to the shaft 8.

A watertight open/close lid (not shown) for inserting/removing the matter to be washed is disposed facing the open/close door 3 in an upper part of the outer drum 2. A large number of through holes (not shown) through which air and water can circulate are formed in a whole peripheral wall of the inner drum 5. A stop position of the inner drum 5 is defined, and an open/close lid (not shown) for inserting/removing the matter to be washed is disposed in a position (upper surface) facing the open/close lid of the outer drum 2 at a stop time.

The driving motor is a motor for rotating the inner drum 5 centering on the shaft 8 of a right/left horizontal direction in the washing operation and the drying operation after ending the washing operation. This driving motor is attached to the other end (inner side of FIG. 1) of the shaft 8, and the inner drum 5 is controlled in such a manner as to be rotated by the driving motor at a low speed at a drying operation time as compared with a washing operation time.

An inner hollow portion 9 is formed in one end (front side of FIG. 1) of the shaft 8, and an air circulation path 72 described later communicates with the inside of the inner drum 5 via a discharge port (not shown) of the hollow portion 9.

A water supply passage (not shown) which is water supply means for supplying water into the inner drum 5 is disposed in an upper part of the main body 1. One end of the water supply passage is connected to a supply water source such as city water via a water supply valve. This water supply valve is controlled to open/close by a control device. The other end of the water supply passage is connected to the outer drum 2, and communicates with the inside. When the water supply valve is opened by the control device, the water (city water) is supplied into the housing chamber 10 in the inner drum 5 disposed inside the outer drum 2 from the supply water source.

Moreover, a water discharge passage (not shown) which is water discharge means for discharging water of the housing chamber 10 in the inner drum 5 is disposed in a lower part of the main body 1, and one end of the water discharge passage communicates with a bottom part of the outer drum 2 via a water discharge valve controlled to open/close by the control device. The other end of the water discharge passage is derived to the outside of the washing/drying machine W, and extends to a water discharge trench and the like.

On the other hand, the air circulation path 72 is constituted sideways from a rear side of the outer drum 2 in the main body 1 of the washing/drying machine W. In this air circulation path 72, air whose heat has been exchanged with a gas cooler 82 as a radiator is discharged into the housing chamber 10 by a blower fan 83 which is blowing means. The air circulation path comprises a duct member 67 on a discharge side, a duct member 68 on a suction side, an air passage 69 formed in a drying unit 80 described later and the like. One end of the duct member 67 is connected/fixed to the outer drum 2 in such a manner as to communicate with the inside of the inner drum 5 (housing chamber 10) via the discharge port of the hollow portion 9 formed in one end (front side of FIG. 1) of the shaft 8, and the other end thereof is connected/fixed to an outlet 69B of the air passage 69 formed in the drying unit 80. One end of the duct member 68 is connected/fixed to the outer drum 2 in such a manner as to communicate with the inside of the inner drum 5 (housing chamber 10) in the outer drum 2, and the other end thereof is connected/fixed to an inlet 69A of the air passage 69. It is to be noted that both the duct members 67, 68 are formed of metals or heat-resistant synthetic resins. The other ends (on the side connected to the outlet 69B and the inlet 69A of the air passage) of the duct members 67, 68 are formed into slightly tapered shapes toward tips.

On the other hand, the drying unit 80 comprises: a refrigerant circuit 95 constituted by successively piping/connecting a compressor 81, a gas cooler 82, an expansion valve 84 which is a pressure reducing device, and an evaporator 85 in an annular shape; and the blower fan 83. Moreover, in the drying unit 80 of the washing/drying machine W of the present embodiment, the refrigerant circuit 95 and the blower fan 83 are integrally constituted, and housed in an insulating box member 90 to thereby constitute a cassette, and the cassette is detachably attached in a predetermined range under center of gravity of the lower part of the drum main body D.

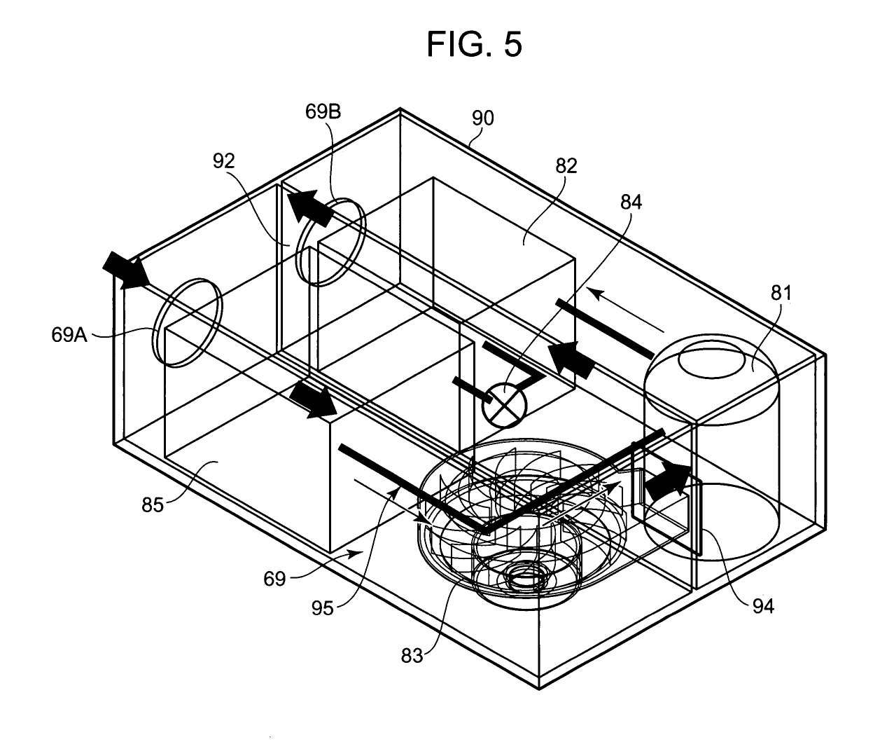

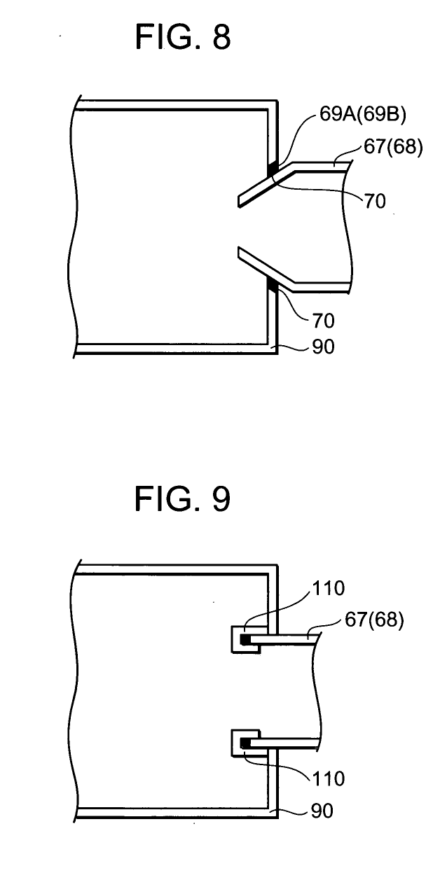

The inlet 69A and the outlet 69B of the air passage 69 are formed in one side surface (innermost positioned face in FIG. 5) of the insulating box member 90. The inlet 69A and the outlet 69B are cylindrical holes, and sealing members 70 such as rubbers are attached to whole peripheries of the holes (FIG. 8).

Moreover, the inside of the insulating box member 90 is divided by an insulating partition member 92, the inlet 69A of the air passage 69 is positioned in one of the insulating box members 90 divided by the partition member 92, and the outlet 69B of the air passage 69 is positioned in the other member. Furthermore, in FIG. 5, a communication hole 94 for connecting one insulating box member 90 to the other insulating box member 90 divided by the partition members 92 is formed in the front partition member 92 in the insulating box member 90. Accordingly, in the insulating box members 90, the air sucked into one insulating box member 90 from the inlet 69A enters the other insulating box member 90 via the communication hole 94, and the air passage 69 discharged from the outlet 69B is constituted.

Moreover, the evaporator 85 is disposed inside one (left-side in FIG. 5) insulating box member 90 divided by the partition member 92, and the blower fan 83 is disposed in front. The drying air in the air circulation path 72 is circulated in the inner drum 5 by the blower fan 83 at a drying operation time, and the drying air heated by the heat exchange with the gas cooler 82 disposed in the air passage 69 of the air circulation path 72 is discharged into the housing chamber 10 in the inner drum 5. The blower fan 83 is disposed adjacent to the communication hole 94, a suction port is disposed on the side of the evaporator 85, and a discharge port is disposed on the side of the communication hole 94.

Furthermore, the gas cooler 82 is disposed inside the other (right-side in FIG. 5) insulating box member 90 divided by the partition member 92, and the compressor 81 is disposed in front. The compressor 81 is disposed in the air passage 69 adjacent to the communication hole 94. That is, the compressor 81 is disposed in such a manner that the air discharged from the blower fan 83 passes through the compressor 81 via the communication hole 94.

By this constitution, the air which has circulated in the housing chamber 10 by the operation of the blower fan 83 and which has dried the matter to be washed flows into the air passage 69 in one insulating box member 90 divided by the partition member 92 from the inlet 69A via the duct member 68 of the air circulation path 72. The air exchanges heat with the evaporator 85, and is cooled and dehumidified. Thereafter, the air is sucked into the blower fan 83 disposed in the front air passage 69, discharged into the other insulating box member 90 from the communication hole 94, passed around the compressor 81, heated by the heat exchange with the gas cooler 82 disposed in the air passage 69 on the side of the outlet 69B, and discharged into the housing chamber 10 from the outlet 69B via the duct member 67.

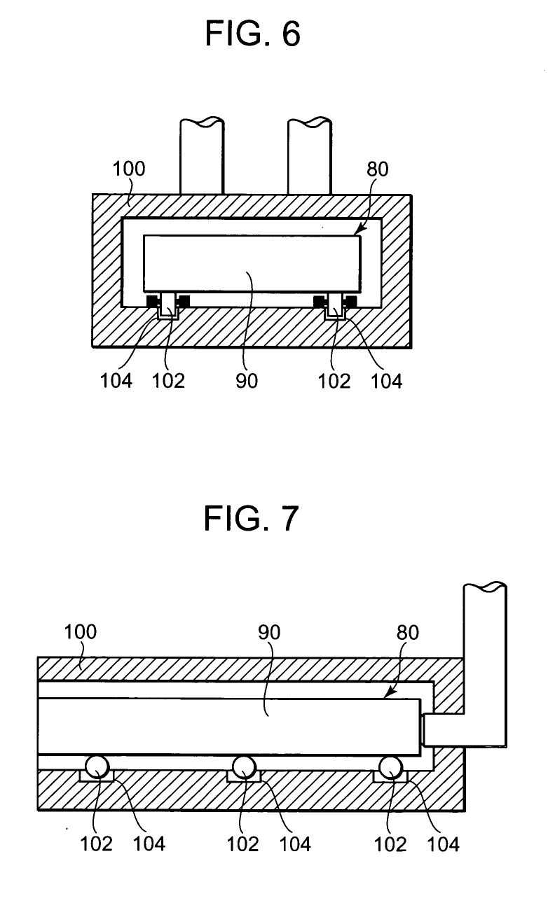

Moreover, as shown in FIG. 6 or 7, a plurality of rollers 102 . . . are attached to the bottom face of the insulating box member 90.

Here, the drum main body D causes vibration•displacement by the rotation of the inner drum 5, and is therefore fixed onto a base 32 positioned in the bottom face of the main body 1 via a suspension 30 having a vibration absorption function in order to reduce vibration•noise. That is, the rotating inner drum 5 is attached onto the base 32 via the outer drum 2 and the suspension 30.

On the other hand, an installation base 100 is attached under the outer drum 2. This installation base 100 is a base for drawably attaching the drying unit 80 housed in the insulating box member 90 and constituted as the cassette under the drum main body D. The front face of the installation base 100 is open, and a plurality of trenches 104 . . . are formed in a bottom part as shown in FIGS. 6, and 7. The trenches 104 . . . are formed in such a manner that the insulating box member 90 is fixed in a predetermined position, when the insulating box member 90 is inserted in the installation base 100, and are formed in positions facing the rollers 102 . . . .

Moreover, two holes (not shown) are formed in the rear face of the installation base 100, and the duct member 67 on the discharge side is inserted/fixed in one hole. The duct member 68 on the suction side is inserted/fixed in the other hole.

Furthermore, the insulating box member 90 containing the drying unit 80 is inserted from the front-face opening of the installation base 100 into a position where all the trenches 104 . . . formed in the bottom part of the installation base 100 match with the rollers 102 . . . formed on the bottom face of the insulating box member 90. By this inserting operation, the respective duct members 67, 68 are connected/fixed to the outlet 69B and the inlet 69A of the air passage 69, and the air circulation path 72 is thereby constituted. It is to be noted that, as described above, the duct members 67, 68 on the side connected to the air passage 69 are formed into shapes tapered toward tips. Therefore, by the inserting operation, the members can be easily connected to the inlet 69A or the outlet 69B. Since the sealing members 70 are attached to the outlet 69B and the inlet 69A of the air passage 69, the respective duct members 67, 68 are connected to the outlet 69B or the inlet 69A of the air passage 69 via the sealing members 70. When the inlet 69A and the outlet 69B formed in the insulating box member 90 are connected to the duct members 67, 68 via the sealing members 70 in this manner, both the members can be easily connected to thereby constitute the air circulation path 72, and a disadvantage that the air in the air circulation path 72 leaks to the outside from the connected portions can be prevented.

It is to be noted that connection of the inlet 69A formed in the insulating box member 90 to the duct member 67, and the connection of the outlet 69B to the duct member 68 may be sealed using O-rings 110 as shown in FIG. 9.

Moreover, a predetermined amount of carbon dioxide (CO₂) which is a refrigerant is sealed in the refrigerant circuit 95, and the refrigerant circuit 95 has a supercritical pressure on a high-pressure side.

It is to be noted that the above-described control device is control means for controlling the washing/drying machine W, and controls operation of the driving motor (not shown), opening/closing of the water supply valve of the water discharge passage, opening/closing of the water discharge valve of the water discharge passage, operation of the compressor 81, throttle adjustment of the expansion valve 84, and air amount of the blower fan 83. Furthermore, the control device also controls the temperature of the drying air passed through the gas cooler 82 in such a manner as to prevent the matter to be washed housed in the inner drum 5 from being discolored or damaged.

Next, an operation of the washing/drying machine W constituted as described above will be described. The matter to be washed and a predetermined amount of detergent in accordance with the amount of the matter to be washed are projected into the housing chamber 10 in the inner drum 5, a power switch and a start switch among the operation switches are operated, and then the control device starts the washing operation. Moreover, the control device opens the water supply valve of the water supply passage (not shown) to thereby open the water supply passage. Accordingly, the water is supplied into the housing chamber 10 of the inner drum 5 in the outer drum 2 from the supply water source. It is to be noted that at this time, the water discharge valve of the water discharge passage is closed by the control device.

When a predetermined amount of water is accumulated in the housing chamber 10 in the inner drum 5, the control device closes the water supply valve to thereby close the water supply passage. Accordingly, the supply of the water from the supply water source is stopped.

Next, the driving motor formed on the side face of the main body 1 is energized/started by the control device, and the shaft 8 rotates. Accordingly, the inner drum 5 attached to the shaft 8 starts rotating in the outer drum 2, and a washing process of the washing operation is started.

After elapse of a predetermined time after starting the washing process, the driving motor is stopped by the control device, the water discharge valve of the water discharge passage is opened, and the water (washing water) in the housing chamber 10 (i.e., in the outer drum 2) of the inner drum 5 is discharged.

Furthermore, when the water in the housing chamber 10 of the inner drum 5 is discharged, the control device operates the driving motor again, and the matter to be washed is dewatered. After executing the dewatering for a predetermined time, the control device closes the water discharge valve of the water discharge passage.

Next, the control device shifts to a rinsing process, and opens the water supply valve of the water supply passage to thereby open the water supply passage. Accordingly, the water is supplied to the housing chamber 10 in the inner drum 5 from the supply water source again. When a predetermined amount of water is supplied to the housing chamber 10 in the inner drum 5, the control device closes the water supply valve to thereby close the water supply passage. Accordingly, the water supply from the supply water source is stopped.

Moreover, after repeating a rotation operation of the driving motor for a predetermined time to thereby perform the rinsing, the control device stops the driving motor, and opens the water discharge valve of the water discharge passage to thereby discharge the rinsing water in the housing chamber 10 to the water discharge passage. When the rinsing water in the housing chamber 10 is discharged, the control device operates the driving motor again, rotates the inner drum 5 as described above, and shifts to a dewatering process to remove water from the matter to be washed. At this time, the control device starts the compressor 81 and the blower fan 83, and starts a preheating operation. After executing this dewatering process for a predetermined time, the control device rotates the inner drum 5 by the driving motor to shift to the drying operation.

In the drying operation, a high-temperature•pressure gas refrigerant discharged from the compressor 81 emits heat in the gas cooler 82, and thereafter reaches the expansion valve 84. The refrigerant does not condense, and the refrigerant circuit 95 indicates a supercritical pressure on a high-pressure side. The refrigerant which has reached the expansion valve 84 is decompressed, and liquefied in the process. Thereafter, the refrigerant flows into the evaporator 85, absorbs heat from a surrounding area, evaporates, and is sucked into the compressor 81. This circulation is performed.

By the operation of the blower fan 83, the air is heated by radiation of the high-temperature•pressure refrigerant in the gas cooler 82, and the drying air at high temperature flows into the hollow portion 9 from the duct member 67 of the air circulation path 72. The drying air which has flown into the hollow portion 9 is discharged into the housing chamber 10 from a discharge port 9A. The drying air discharged into the housing chamber 10 warms a matter to be dried stored in the inner drum 5 (housing chamber 10) to thereby evaporate a water content, and dries the matter to be dried. The moisture-containing air which has dried the matter to be dried passes through the housing chamber 10, flows to the outside of the inner drum 5 from the through holes (not shown), and passes through the duct member 68 of the air circulation path 72. The air is sucked into the air passage 69 formed in the insulating box member 90 from the inlet 69A, and introduced and passed into the evaporator 85 disposed in the passage.

The water content (water content evaporated from the dried matter) contained in the air from the housing chamber 10 is condensed on the surface of the evaporator 85 while passing through the evaporator 85, and drops as water droplets. The fallen droplets are discharged to an external discharge ditch or the like from the water discharge passage via a drain pipe (not shown).

The dried air from which humidity is removed by the evaporator 85 is sucked into the blower fan 83, and discharged toward the communication hole 94. Moreover, the air passed through the communication hole 94 passes around the compressor 81. At this time, the air cooled by the evaporator 85, sucked into the blower fan 83, and discharged is passed around the compressor 81. Accordingly, the compressor 81 heated by the operation can be cooled, durability of the compressor 81 is enhanced, and the heat generated from the compressor 81 can be utilized.

Moreover, the air which has cooled the compressor 81 flows into the gas cooler 82, and is heated. Moreover, the air enters the duct member 67 from the outlet 69B of the air passage 69, and is sent to the hollow portion 9 of the shaft 8. In the same manner as described above, the air is discharged into the housing chamber 10 in the inner drum 5, the water content is taken from the matter to be dried in the inner drum 5, and the matter is dried. This circulation is repeated.

When the drying operation is executed for a predetermined time by the control device, the matter to be dried of the housing chamber 10 in the inner drum 5 is completely dried. The air in the air circulation path 72 is heated by the gas cooler 82 in this manner, and dehumidified by the evaporator 85 so that the matter to be dried can be efficiently dried. When the refrigerant indicating a supercritical pressure on the high-pressure side of the refrigerant circuit is used like carbon dioxide, a large heating capability can be obtained in the gas cooler 82.

On the other hand, as described above, the drying unit 80 is attached under the outer drum 2. Accordingly, the drying unit 80 functions as a deadweight with respect to the drum main body constituted of the outer drum 2 and the inner drum 5. The amplitude of vibration generated in rotating the rotary drum is suppressed, and resonance frequency drops.

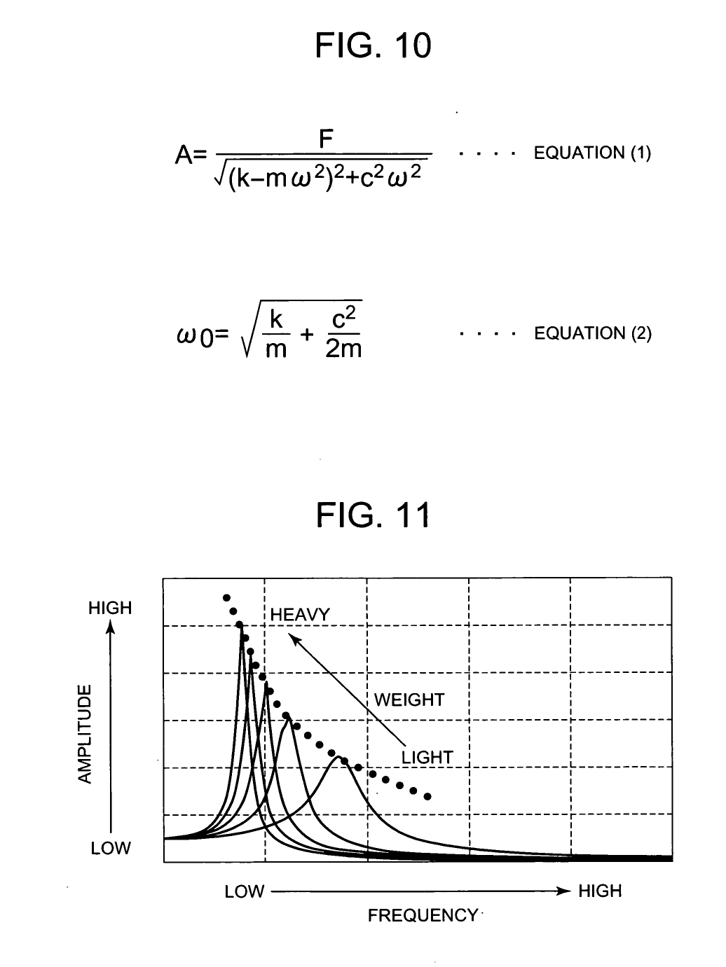

That is, the amplitude can be simply represented by equation (1) of FIG. 1. The resonance frequency can be simply represented by equation (2) of FIG. 10. In the equations (1) and (2), A denotes an amplitude, F denotes a force, k denotes a spring constant, m denotes a weight, c denotes a viscosity, ω denotes an angular frequency, and ω₀ denotes a resonance frequency. FIG. 11 shows a change of the resonance frequency ω₀ calculated based on the equations (1), (2) accompanying a change of the weight m. It is seen from FIG. 11 that the resonance frequency ω₀ drops with an increase of the weight m. Therefore, when the drying unit 80 is attached under the outer drum 2 as in the present invention, the resonance frequency ω₀ remarkably drops. When the drying unit is attached under the drum main body D, the amplitude of the vibration generated in rotating the inner drum 5 is suppressed, and the resonance frequency ω₀ can be lowered. Consequently, the vibration•noise during the operation can be remarkably reduced.

Especially, in this case, a flexible hose for absorbing vibration•displacement does not have to be used in the respective duct members 67, 68 of the air circulation path 72 which connects the drying unit 80 constituted of the refrigerant circuit 95 and the blower fan 83 to the drum main body D, and component costs can be reduced.

Moreover, as in the present embodiment, the refrigerant circuit 95 and the blower fan 83 are integrally constituted in the insulating box member 90 to thereby constitute the drying unit 80 as the cassette, and the cassette is detachably attached under the drum main body D. Therefore, assembly operability at production and maintenance times is remarkably enhanced.

Furthermore, since the drying unit 80 is disposed in a predetermined range below the center of gravity of the drum main body D, the amplitude of the vibration of the drum main body D can be securely suppressed.

Additionally, as in the present embodiment, the refrigerant circuit 95 and the blower fan 83 are integrally constituted in the insulating box member 90 to thereby constitute the drying unit 80 as the cassette, and the unit is detachably attached. Therefore, when both the heating by the gas cooler 82 and the dehumidifying by the evaporator 85 are performed in the refrigerant circuit 95, the drying operation of the matter to be washed is efficiently performed, and the assembly operability at the production and maintenance times is remarkably enhanced. When the insulating box member 90 is attached under the drum main body D, the center of gravity of the drum main body D is lowered, generation of the vibration at the operation time is suppressed, and noises can be reduced.

Moreover, as described above, the insulating box member 90 is drawably attached, the air circulation path 72 is constituted by the inserting operation, and therefore an assembly operation can be further facilitated.

### Embodiment 2

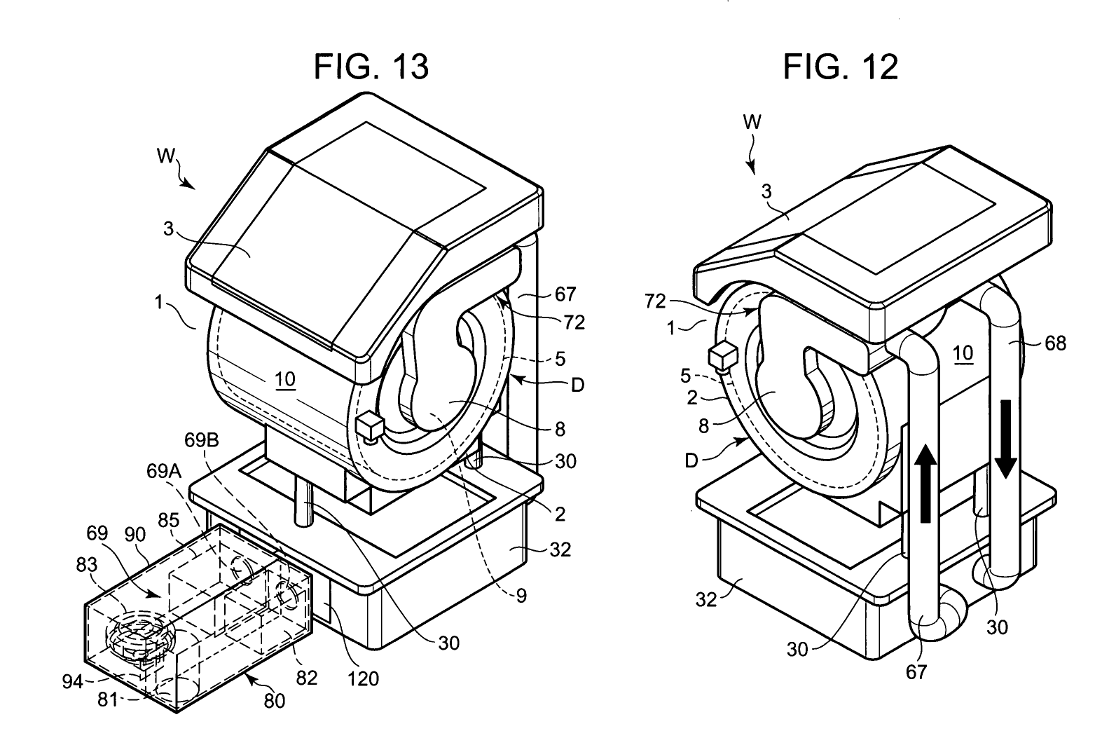

Next, another embodiment of a drying machine to which the present invention is applied will be described with reference to FIGS. 12 and 13. It is to be noted that in FIGS. 12 and 13, components denoted with the same numerals as those of FIGS. 1 to 9 produce similar effects.

In FIG. 12, reference numeral 120 denotes an installation hole for installing a drying unit 80, and the installation hole 120 is formed in a base 32. The installation hole 120 has an opening in the front face of the base 32, and an insulating box member 90 of the drying unit 80 is drawably attached from the opening in the front face. A plurality of trenches 104 . . . are formed in the bottom part of the installation hole 120 in the same manner as in the installation base 100. By the trenches 104 . . . when the insulating box member 90 is inserted into the installation hole 120, rollers 102 . . . attached to the lower part of the insulating box member 90 are held.

Moreover, two holes (not shown) which communicate with the installation hole 120 are formed in the rear face of a base 32, and a duct member 67 on a discharge side is inserted in one hole, and connected/fixed into an outlet 69B of the insulating box member 90 of the drying unit 80 via sealing members 70. A duct member 68 on a suction side is inserted into the other hole, and connected/fixed into an inlet 69A of the insulating box member 90 via the drying unit 80 (see FIG. 8). When the insulating box member 90 is connected to the respective duct members 67, 68 via the sealing members 70, a disadvantage that the air in an air circulation path 72 leaks to the outside from connected portions can be prevented.

It is to be noted that the duct members 67, 68 of the present embodiment are formed of metals or heat-resistant synthetic resins, and constituted of materials which entirely or partially have flexibility, for example, flexible hoses.

Even in the case where the drying unit 80 housed in the insulating box member 90 is drawably attached into the installation hole 120 formed in the base 32, a center of gravity of a drum main body D itself lowers, stability increases, and vibration•noise during operation can be remarkably reduced in the same manner as in the above-described embodiment.

Moreover, as to the drying unit 80, a refrigerant circuit 95 and a blower fan 83 are integrally constituted in the insulating box member 90, the drying unit 80 is constituted as a cassette, and detachably attached under an outer drum 2, and therefore assembly operability at production and maintenance times are remarkably enhanced.

Especially, in the present embodiment, since the drying unit 80 is attached into the base 32 positioned in a lowermost part of a washing/drying machine W, the center of gravity can be further lowered, and further vibration suppressing effect can be obtained.

In this case, flexible hoses for absorbing vibration•displacement are used in duct members 67, 68 which connect the drying unit 80 to the drum main body D, and accordingly vibration transmitted to the drying unit 80 by the rotation of the inner drum 5 can be remarkably reduced.

It is to be noted that in the above-described embodiments, the refrigerant circuit 95 and the blower fan 83 are integrally constituted and housed in the insulating box member 90 to thereby constitute the drying unit 80 as the cassette, and the unit is attached in a predetermined range below the center of gravity of the lower part of the drum main body D. The refrigerant circuit 95 and the blower fan 83 may be separately constituted, and attached under the drum main body D, or the only refrigerant circuit 95 including the compressor 81 may be attached. The compressor 81 only may be attached under the drum main body D. Furthermore, in the embodiments, the drying unit 80 housed as the cassette in the insulating box member 90 is drawably attached. Moreover, by the inserting operation, the air circulation path 72 is formed. However, the present invention is not limited to this example as long as at least the drum main body D is attached to the base 32 via the suspension 30, and the compressor 81 is attached under the drum main body D.

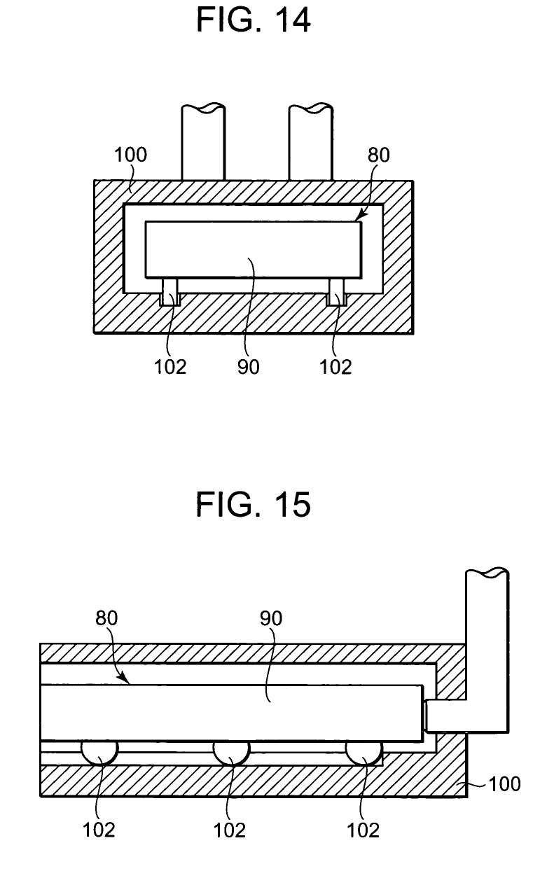

Furthermore, in the above-described embodiments, the trenches 104 . . . are formed in the installation base 100 or the bottom part of the installation hole 120 in such a manner as to face the rollers 102 . . . attached to the bottom face of the insulating box member 90 of the drying unit 80. When the insulating box member 90 is inserted, all the rollers 102 . . . are fitted and fixed in the trenches 104 . . . in a predetermined installation position. The present invention is not limited to this example, and the trenches may be formed in a predetermined position from the opening in the front face as shown in FIGS. 14 and 15.

Furthermore, the present invention is applied to the washing/drying machine having washing and drying functions in the embodiments, but may be, needless to say, applied to a drying machine which has an only drying function.

1. A drying machine which executes a drying operation of a matter to be dried in a housing chamber constituted in a rotary drum of a drum main body, the drying machine comprising:
a refrigerant circuit constituted by successively piping/connecting a compressor, a radiator, a pressure reducing device, and an evaporator in an annular shape; and
an air circulation path for discharging air whose heat has been exchanged with the radiator into the housing chamber by blowing means, and allowing the air which has passed through the housing chamber to exchange the heat with the evaporator,
wherein the drum main body is attached to a base via a suspension, and the compressor is attached to a lower part of the drum main body.

2. The drying machine according to claim 1, wherein the refrigerant circuit including the compressor, or the refrigerant circuit and the blowing means are attached to the lower part of the drum main body.

3. The drying machine according to claim 2, wherein the refrigerant circuit, or the refrigerant circuit and the blowing means are integrally constituted, and detachably attached to the lower part of the drum main body.

4. The drying machine according to any one of claims 1, 2, and 3, wherein the compressor, the refrigerant circuit, or the refrigerant circuit and blowing means are disposed in a predetermined range below a center of gravity of the drum main body.

5. A drying machine which executes a drying operation of a matter to be dried in a housing chamber constituted in a rotary drum of a drum main body, the drying machine comprising:
a refrigerant circuit constituted by successively piping/connecting a compressor, a radiator, a pressure reducing device, and an evaporator in an annular shape; and
an air circulation path for discharging air whose heat has been exchanged with the radiator into the housing chamber by blowing means, and allowing the air which has passed through the housing chamber to exchange the heat with the evaporator,
wherein the refrigerant circuit and the blowing means are integrally constituted as a cassette, and detachably attached

6. The drying machine according to claim 5, wherein the cassette is attached to the lower part of the drum main body.

7. The drying machine according to claim 5, wherein the cassette is attached to a base to which the drum main body is attached.

8. The drying machine according to any one of claims 5, 6, and 7, wherein the cassette is drawably attached, and the air circulation path is constituted by an inserting operation.
